(19) United States
(12) Patent Application Publication
(10) Pub. No.: US 2002/0167486 A1
(43) Pub. Date: Nov. 14, 2002

(54) Sensing chair as an input device for human-computer interaction

(76) Inventors: Hong Z. Tan, West Lafayette, IN (US); David S. Ebert, West Lafayette, IN (US)

Correspondence Address: Bruce J. Bowman, Maginot, Moore & Bowman, LLP, Bank One Center/Tower, 111 Monument Circle, Suite 3000, Indianapolis, IN, 46204-5115, US

(21) Appl. No.: 10/118,883

(22) Filed: Apr. 9, 2002

Related U.S. Application Data
(60) Provisional application No. 60/282,515, filed on Apr. 9, 2001.

(51) Int. Cl. G09G 5/00

(52) U.S. Cl. 345/156

(57) ABSTRACT

A body support structure such as a chair provides an input device for a computer or computer-controlled apparatus via sensors associated with the chair. The sensing chair sensor or sensors covering the seat and/or seat back. The sensing chair determines an occupant's position, movement, weight shifting, and/or other parameters regarding the occupant. In one form, the sensor is adapted to obtain pressure and pressure distribution of the occupant in the sensing chair, both static and real-time. The pressure and/or pressure distribution data/signals for the occupant is processed to provide control/control signals to a processing system, computer, and/or computer-controlled apparatus. The sensing chair provides novel opportunities for human-computer interaction, such as input for the automobile industry, the office industry, for interactive graphical user interfaces/displays, and for computer games and gaming systems.

This non-provisional U.S. patent application claims the benefit of and priority to co-pending provisional U.S. patent application serial No. 60/282,515 filed Apr. 9, 2001 entitled “Sensing Chair as an Input Device for Human-Computer Interaction.”

1. Field of the Invention

The present invention relates generally to input devices for electronic components and, more particularly, to hands-free input devices for electronic components such as computers and/or computer controlled devices.

2. Description of the Prior Art

Computers, computer-controlled and/or processor-controlled devices, collectively computers, are utilized in a variety of applications from the elementary to the complex. Many of such computers require or optionally accept input from an external source. The received external input is processed by the computer for a particular purpose and/or interaction with an associated application of the computer.

External input may be obtained from a variety of sources such as by discrete sensors in the case of an anti-lock braking application, an electronic controller that acquires and/or selects data in a data system, and/or by human input through interface with a human-actuated input device such as a joystick, controller or the like. In human-actuated input systems most human-actuated input devices are in the form of hand controlled, operated and/or actuated devices. Common hand operated data input devices are the joystick, a mouse or a ball, or a combination of joystick, ball and/or mouse.

Current technology, however, is pushing for development of human-controlled input devices that are not just hand-controlled. Various technologies are being developed that allow human interface with computers via non-hand-controlled input devices. The non-hand-controlled input devices utilize a part of the body other than or in addition to the hand such as an eye through eye movement, a head through head movement, and/or a voice through voice command. These devices and/or methods, however, do not utilize the body itself, the whole body and/or body characteristics as human input data.

It is known to utilize the body to obtain static pressure distribution data. The acquired data, however, is then taken off-line for human evaluation/analysis. Applications or scenarios that utilize static pressure distribution data include furniture designing for seating evaluation, dentics for dentures, hospitals for evaluation of beds, and boot designers for development of combat boots. These systems and/or applications, however, do not provide any real-time human-controlled input system that utilizes a body as real-time data input, let alone a system that can be used as a front-end to drive other applications.

It would be desirable to have a system, apparatus and/or method that provides an input device to a computer that utilizes a user's body and/or body characteristics in real-time as input data to a computer system. The system, apparatus and/or method would further desirably be used as input to a processing system associated with or integrally as the computer system. Further, the system would desirably provide front-end data to drive an application.

It would be further desirable to have a system, apparatus and/or method that provides real-time pressure distribution data for an occupant seated in a chair that provides front-end data to drive various applications.

### SUMMARY OF THE INVENTION

The present invention is a human-controlled input data system, method and/or apparatus. Particularly, the present invention is a body-controlled data input device.

In one form, the system, method and/or apparatus obtains body data particularly an occupant's body position, movement (weight shifting) and/or transitional phases when the body is in a body support structure as data parameters. Such data parameters may be used for controlling a processing application. Obtained body data parameters are used as input to control the processing application.

In particular, in one form, the present invention is a sensing chair for human-controlled input as a body support structure that includes body sensors that obtain static pressure and/or real-time pressure (i.e. body movement) data (collectively, body data) and converts the body data into control signals for a processing application. The application may be a game, an air-bag deployment system, and/or any other application that utilizes external data as input, especially external data with regard to a person.

In another form, the present invention is an input device that comprises a body support structure, a sensor associated with the body support structure and operative to obtain data regarding body dynamics of a person with respect to the body support structure, and an interface in communication with the sensor and operative to transform the data into control signals.

In yet another form, the present invention is an input system. The input system includes a chair, a sensor associated with the chair and operative to obtain data regarding an occupant of the chair, an interface in communication with the sensor and operative to transform data regarding an occupant of the chair into control signals, and a computer-controlled device in communication with the interface and operative to utilize the control signals.

In still another form, the present invention is a method of providing input signals to a processing application. The method includes obtaining data regarding a person seated in a chair; transforming the obtained data into control signals; and providing the control signals to the processing application.

The present invention provides an input device for a computer, processing apparatus, and/or computer-controlled apparatus that can be used in various environments/applications. Exemplary environments/applications include the automobile industry, the office environment, interactive graphic displays, and computer games/game controllers. The automobile industry may use the present invention to detect whether a car seat is occupied, estimate the weight and size of its occupant, and determine the occupant's position within the car seat. The office may use the present invention as a posture coach to monitor posture of an occupant in a chair and provide feedback to the occupant. Such feedback may include a visual indication of posture, an audio indication of posture, and/or other response.

In other forms, the present invention may also be used in an environment such as a teleconference environment to control aspects of the teleconference wherein, for example, one may zoom in on the remote speaker by leaning forward, or pan the remote camera by shifting weight to the left or right. An interactive graphic display may use the present invention to control certain aspects of the graphic display through body movement. Further, the gaming industry may use the present invention as a hands-free manner of providing input to control various aspects of a game, such as vehicle control. Various body support structures are contemplated.

Different drivers may be developed for different applications utilizing the obtained body data. Each driver defines different attributes and/or functions for the system or processing application based upon body position and pressure.

It is an advantage of the present that the head and/or hands are free from use by the present body input device.

### BRIEF DESCRIPTION OF THE DRAWING

The above-mentioned and other features and advantages of this invention, and the manner of attaining them, will become more apparent and the invention will be better understood by reference to the following description of an embodiment of the invention taken in conjunction with the accompanying drawing being comprised of a plurality of figures, wherein:

FIG. 1 is a block diagram of a general application of the present invention;

FIG. 2 is a block diagram of an exemplary system of the general application of FIG. 1;

FIG. 3 is a more detailed block diagram of the system of the exemplary embodiment of FIG. 2;

FIG. 4 is an exemplary application diagram of the exemplary embodiment of FIG. 3;

FIG. 5 is a block diagram of another exemplary system in accordance with the principles of the present invention;

FIG. 6 is a block diagram of another exemplary system in accordance with the principles of the present invention;

FIG. 7 is a flow diagram of an exemplary manner of operation of the present invention;

FIG. 8 is a body pressure map illustrating a typical pressure distribution map for “left leg crossed” obtained in accordance with the principles of the present invention; and

FIG. 9 is a three-dimension depiction of pressure distribution for a posture of “sitting upright” obtained in accordance with the principles presented herein.

Corresponding reference characters indicate corresponding parts throughout the several views.

### DETAILED DESCRIPTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

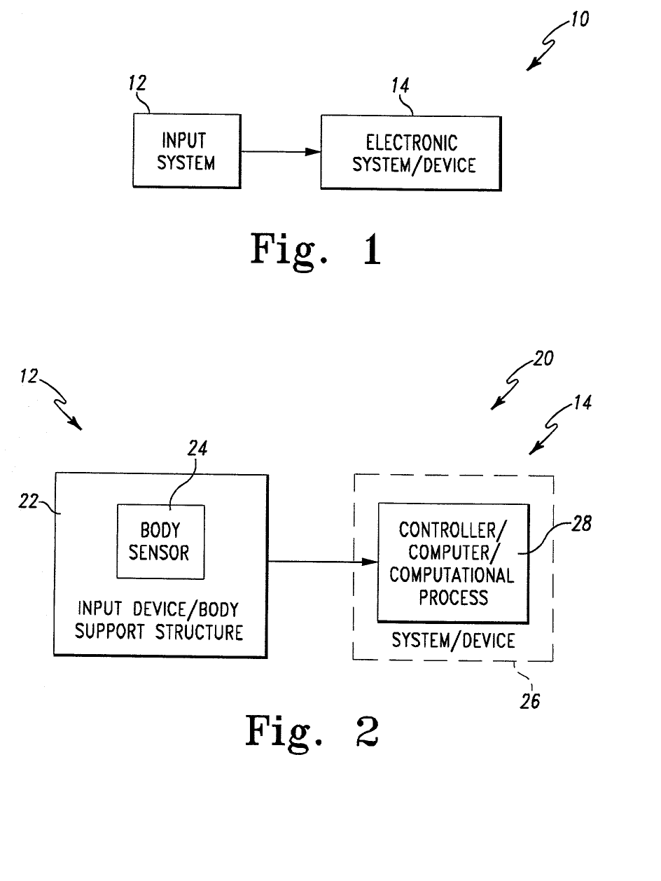

Referring now to FIG. 1, there is shown a block diagram of an exemplary embodiment of a general application/environment of and/or for the present invention, generally designated 10. The system 10 includes an electronic system/device 14, encompassing all types of electronic processing systems and/or devices such as computers, computer-controlled devices, processing components, controllers, and control components, and the like, collectively referred to herein as “computer” unless otherwise indicated. In accordance with an aspect of the present invention, the system includes an input device generally designated 12 that is in communication with the computer 14. The input device 12 obtains input data and/or signals and transmits or forwards the input signals to the computer 14. The computer 14 processes the received signals according to an application or applications associated with the computer 14 in order to achieve a desired result, purpose and/or function.

FIG. 2 depicts an exemplary application and/or environment in which the present invention may be used, generally designated 20, utilizing the building blocks of FIG. 1. The input device 12 includes a housing or physical structure 22 that supports or includes a body data generator/gatherer body sensor, body transducer, or the like 24, collectively hereinafter referred to as a body sensor. The body sensor 24 is operative to obtain input data/data signals from or with regard to a body (i.e. a person) and forward or transmit the obtained body data/data signals to the controller/computer 28.

Particularly, the body sensor 24 is operative to obtain static (discrete) and dynamic real-time body position data. The computer 28 is typically part of an exemplary system 26 that processes and/or utilizes body data signals in accordance with the principles present herein. In one form, the computer/system 14 may be an entertainment or game controller or console, a computer such as a personal computer (i.e. a “PC”), a module or electrical component(s) of a system such as an air-bag deployment system/processor for a vehicle, office applications such as a work positioning system, video conferencing and/or posture monitoring, and/or other type of device.

The body sensor 24 is operative to obtain data and/or data signals regarding a particular aspect of the body or an effect produced by the body such as movement and/or shift in body position. The data may be pressure and/or weight exerted onto a pressure/weight transducer. Even more particularly, in one embodiment, the body sensor 24 is operative to obtain data/data signals regarding pressure and/or pressure distribution data exerted by the body on the device 22 both static and/or dynamic. The body sensor 24 may be embodied on, in or within a body sensor device or housing such as a chair to detect body weight and movement of a body or person while seated in the chair.

In accordance with an aspect of the present invention, real-time movement data with respect to the body in the chair is obtained by the body sensor 24 and translated into a real-time body pressure map and/or real-time body position data. Body pressure and/or change in body pressure overall body pressure within a particular location of the chair and/or body pressure movement is recognized as characteristic of a particular position (e.g. slouching, sitting with crossed legs, rigid posture, and the like). Minute and/or controlled changes in particular muscles of the body can provide input as well. Body sensor data from the body sensor 24 is input to a controller, computer, or computational process 28, collectively “controller”, of a system 26 incorporated as part of the electronic device 14. The body sensor data is processed by the controller 28 such that the body sensor data is used as input control data.

FIG. 3 illustrates another embodiment of the present invention wherein the device 22 is a chair that includes the body sensor 22. Data from the body sensor 22 is fed to an interface card or board 30 that is operative to receive the body sensor data signals. The interface card or board 30 forwards the conditioned signals to an input driver 32 that is operative to transform the conditioned body sensor signals into data and/or control signals for the computer, electronic component, and/or application 34 of the system 26.

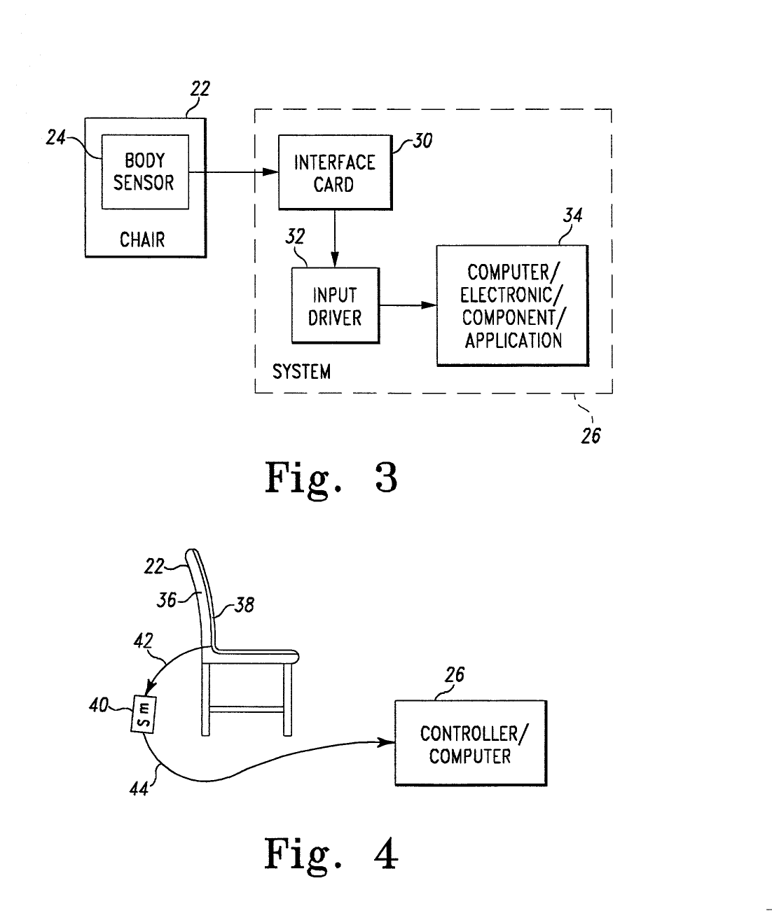

A particular application for the device 22 as a chair is depicted in FIG. 4 and reference is now made thereto. The chair 22 includes a seat and seat back 36 that has a body sensor embodied as skin or layer 38 placed thereover. The body sensor 38 coupled to a sensor multiplexer unit 40 via a communication cable 42. The multiplexer unit 40 obtains raw body sensor data from the body sensor 38. In one form, the body sensor 38 is operative to obtain pressure and/or pressure distribution data from an occupant of the chair 38 both statically and/or in real-time. The multiplexer 40 then multiplexes the raw body sensor data to create a data stream that is forwarded to the controller/computer 26 via a communication cable 44.

In one form, the body sensor 24 may be formed of a pressure distribution measurement system manufactured by Tekscan, Inc. of South Boston, Massachusetts. The Tekscan pressure distribution measurement system utilizes two ultra-thin (0.10 mm) sensor sheets, each with an array of 42 by 48 sensing units with 10 mm spacing that are embodied into the sensor 38 of the chair cushion or seat structure (seat bottom and seat back) so as to be essentially surface mounted onto the chair 22. The sensor may be placed within a protective cover, molded into the chair and/or the like. Each sensing unit outputs an 8-bit raw pressure reading that can be converted to PSI (pounds per square inch), mmHG (millimeters mercury) units with or without calibration, or other measurement system.

The chair 22 thus provides a structure for a human-controlled data acquisition system. As a person (body) moves, changes position, sits in the chair or stands from, the chair, the body/chair (24/22) obtains pressure data regarding the body and/or static and dynamic (real-time) body pressure/movement. Various discrete pressure data points may be used to obtain pressure distribution maps. The pressure distribution maps may be static and/or dynamic.

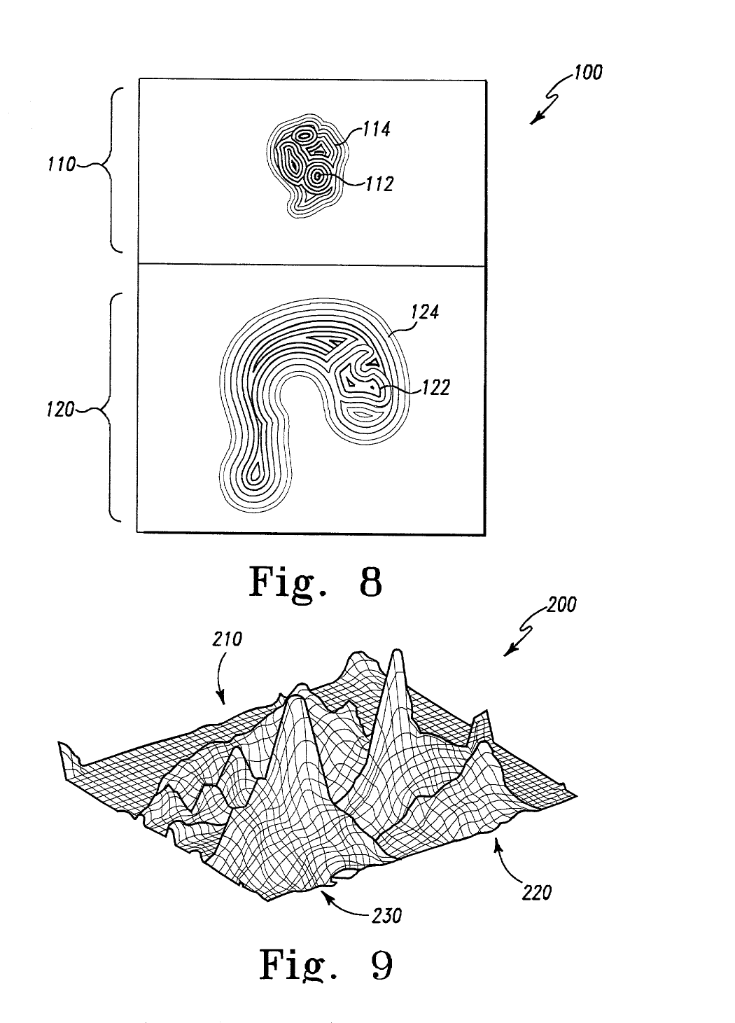

FIG. 8 shows a typical pressure distribution map 100 for a “left leg crossed” utilizing the principles of the present invention. The upper or top half 110 of the pressure distribution map 100 is from the back portion of the chair 22 while the lower or bottom half 120 of the pressure distribution map 100 is from the seat portion of the chair 22. To understand the orientation of the pressure map 100, imagine standing in front of the chair and its occupant, and unfolding the chair so that the backrest and the seat of the chair lie in the same plane. Therefore, the top, bottom, left and right sides of the pressure map shown in FIG. 8 correspond to the shoulder area, knee area, right and left sides of the occupant, respectively. This 2-D image maps the 8-bit raw pressure readings directly into the intensity of the corresponding image pixel, with dark contours indicating high pressure points and lighter contours indicating low pressure points. In FIG. 8, the upper half 110 shows various contours representing different areas of like pressure. The contour 112 indicates higher pressure while the contour 114 indicates lower pressure. The other contours indicate different pressure areas. In the same manner, the lower half 120 shows various contours representing different areas of like pressure. The contour 122 indicates higher pressure while the contour 124 indicates lower pressure. Thus, an occupant seated with left leg crossed would produce the map 100 of FIG. 8. The same type of information can be displayed as a three dimensional (3-D) surface. As well, other body parts can be used and mapped as described herein, from various body support structures.

FIG. 9 shows a 3-D map generally designated 200 for the posture “sitting upright.”This may be generated from a distribution map of one “sitting upright” in the same manner as the “left leg crossed” distribution map 100 of FIG. 8. The multiplexed pressure map may then be sent to a processor such as a Pentium® PC. An application program interface (API) such as one by Tekscan Inc. allows capture of the data in real time. According to one aspect of the present invention, a posture classification algorithm was developed in Visual C++programming language in a Windows 98® environment. It should be appreciated, however, that the programming language and operating system are exemplary, as others may be used. In FIG. 9, the higher the peak, the higher the pressure. Conversely, the lower the peak to flat, the lower the pressure to no pressure. In FIG. 9 the area 210 represents the buttocks, the area 220 represents the left leg, and the area 230 represents the right leg.

In FIG. 5, there is depicted another system, generally designated 50, that obtains and utilizes body information gathered by a chair 52 through a sensor grid 54. Body data/data signals regarding pressure (static and dynamic) are sent to a sensor signal multiplexer 56 that is in communication with the chair 52/sensor grid 54. The multiplexer 56 formats the data signals to be sent to a data acquisition and buffer board or card 62 within a device 60. From the data acquisition and buffer board 62 the received body data signals are processed accordingly as control signals and used to drive a graphical user interface 66. Real-time movement of the occupant in the chair 52 provides control signals to the GUI 66.

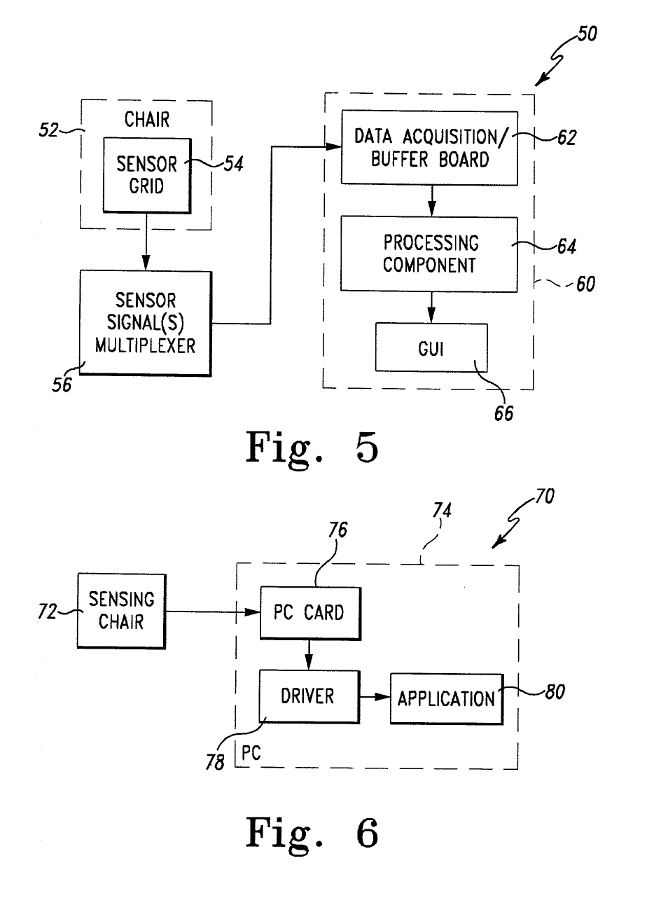

In FIG. 6, there is depicted another system, generally designated 70, that obtains and utilizes body information gathered by a sensing chair 72 (i.e. a chair with body sensors). Data from the chair 72 is received by a card 76 within a computer or computer controlled device such as a game controller 74. A driver 78 transforms the data into control data for the application 80. The application 80, such as a game, uses the body data as input or control signals. The driver can be written as any program to provide an interface between the sensor data and the application.

In particular, the following provides the manner in which the sensor obtains and processes the pressure data for the body. As a first step towards an intelligent chair that can sense and interpret its occupant's actions and intentions per the principles presented herein, classification of static (i.e., steady-state) sitting postures were obtained. The real-time system according to the present invention uses a PCA-based (Principal Components Analysis) algorithm that has been successfully applied to the problem of computer face recognition. The key to the PCA-based approach is to reduce the dimensionality of data representation by finding the principal components of the distribution of pressure maps, or equivalently, the eigenvectors of the covariance matrix of a set of training pressure maps.

The present PCA-based Static Posture Classification algorithm involves two separate steps: training and posture classification. In the first step, training data for a set of K predefined static postures are collected. Pressure maps corresponding to the same posture are used to calculate the eigenvectors, termed the eigenposture space, that best represent the variations among them. The process of computing one such eigenposture space can be illustrated as follows. Each of a total of M training pressure maps (Pm, m=1, . . . , M) is raster-scanned to form a vector of 4032(2×42×48) elements. These vectors are first subtracted by their average. The mean-adjusted vectors, φ_{M}(m=1, . . . , M), are then used to compute the covariance matrix C:

$$C = \frac{1}{M} {\sum }_{i = 1}^{M} {Φ}_{i} {Φ}_{i}^{T} ,$$

from which a set of M eigenvectors (uᵢ, i=1, . . . , M) are calculated such that their corresponding eigenvalues (λᵢ, i=1, . . . , M) are monotonically decreasing (λ₁●λ₂. . . ●λ_{M}). These eigenvectors (uᵢ) can be thought of as forming an M-dimensional eigenposture space where a 4032-element pressure-map can be represented by the M weights of its projection onto this eigenspace. The representation of each pressure map has thus been effectively reduced from a 4032-dimensional space to an M-dimensional space (M<<4032). Furthermore, only the first M′(M′<M) eigenvectors whose eigenvalues are the largest are chosen and used to further improve computational efficiency. This process is repeated for all static postures.

Given a test pressure map Pₜ, the second step of posture classification proceeds as follows. The test map (Pₜ) is first projected onto the eigenposture spaces calculated during the training step. This is done by subtracting the average pressure map for each posture from Pₜ, and finding the inner dot product of the mean-adjusted posture map (φₖ, k=1, . . . K) with each of the eigenvectors in the corresponding eigenposture space. The result is a point in k-th eigenposture space specified by the weights wₖ(i)=φₖ^{t}·uᵢ where uᵢ denotes the i-th eigenvector in the k-th eigenposture space. These weights are used to calculate the reconstruction of Pₜ in each of the eigenposture spaces as φ′ₖ=Σwₖ(i)·uᵢ (the summation is over i=1 to M′). The distances between Pt and its K reconstructions, the so-called distance from posture space (DFPS), can then be computed as ξₖ²=||φₖ−φ′ₖ ||². To the extent that Pₜ is well represented by one of the K eigenposture spaces (as indicated by a small εₖ), the corresponding posture label (k) is used to classify Pₜ. Finally, if the smallest εₖ value is above a preset empirical threshold, the test pressure map Pₜ is classified as “unknown.”

The present posture classification system is trained with sitting postures collected from 30 subjects (15 males and 15 females). Each subject contributed 5 samples for ten (i.e., K =10) typical sitting postures including sitting upright, right leg crossed, leaning forward, etc. Ten modular eigenposture spaces, each based on 150 (i.e., M=150) training samples, are constructed. During classification, a new pressure map is projected onto the ten eigenposture spaces using the first M′=15 eigenvectors (a compromise between performance and computation time). Overall classification accuracy is between 85% (for new users) and 96% (for familiar users who contributed training samples).

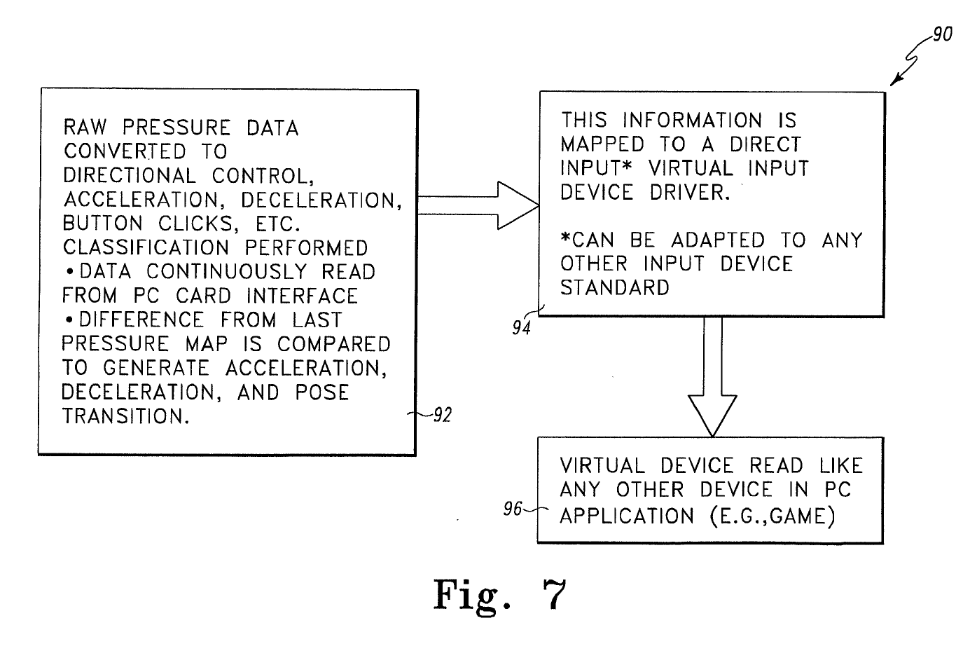

Referring to FIG. 7, there is shown a general flow chart, generally designated 90, illustrating a manner of operation of an aspect of the principles of the present invention. In step 92, raw pressure data that has been obtained from the sensor is converted to directional control, acceleration, deceleration, button clicks, etc. Thereafter, classification is performed wherein data is continuously read from the computer card interface. A difference from a last pressure map is compared to a current pressure map to generate acceleration, deceleration, and pose transition. In step 94, the information obtained/processed in step 92 is mapped to a virtual input device driver, such as Direct Input (or any other standard). From this, in step 96, the virtual device is read like any other device in an application such as control in a computer game.

The present invention utilizes the classification of dynamic postures using hidden Markov modeling. This system allows one to classify not only static postures such as “right leg crossed,” but also transitional postures such as “moving from sitting upright to slouching.”

Another form of the present invention includes a back display that can be draped over the back of a chair or built into a vest. This system can display directional signals to the back of a user. It can be useful as a haptic navigation guidance system or situation awareness display for drivers, or as a spatial orientation display for pilots and astronauts who suffer from spatial disorientation. The present sensing chair and the chair display may be integrated to create a smart chair that senses and responds to its occupant's actions.

The present invention can continuously track the pressure distribution in a chair as the result of an occupant, and classify the steady-state postures into one of the ten predefined postures “known” to the chair. The capability of this Static Posture Classification system can be demonstrated by using computer graphics and visualization techniques to display the pressure tracking and posture classification results as presented herein. Various scenarios may be presented such as:

Scenario 1: Visualization of pressure map

As a person moves in the chair, pressure distribution changes in the seat and the backrest of the chair. The pressure map, viewed as a 3-D surface (see for example FIG. 9), can be visualized as terrain with picture, plain terrain profile, and as input for a dynamic image mixing/painting application. A feature parameter extracted from the pressure maps, such as center of force, can also be visualized as the 2-D coordinate of a mouse to drive other software.

Scenario 2: Sitting posture classification

The output (i.e., posture label) of the Static Posture Classification system can be used to select an image that shows someone sitting in a chair with the corresponding posture.

Scenario 3: Chair driven computer games

A DirectInput®, DirectX®, or similar interface can be written for the present invention (i.e. chair) that will allow it to be used for controlling several computer or game controller games, such as those from Electronic Arts, including a driving simulator (e.g., Nascar, Need for Speed), a sports game (e.g., Madden Football, NHL Hockey, snowboarding), and a first person action game (Alice, Undying). By using a standard such as the DirectInput® standard, the driver for the present chair should be able to control the input to many PC/gaming applications. Using the user's positional leaning (left, right, front, back) and dynamic pressure shifting could provide a very simple to use, intuitive, fun interface for games and other applications.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the claims.

What is claimed is:

1. An input device comprising:
a body support structure;
a sensor associated with said body support structure and operative to obtain data regarding body dynamics of a person with respect to said body support structure; and
an interface in communication with said sensor and operative to transform said data into control signals.

2. The input device of claim 1, wherein said sensor is operative to obtain pressure data regarding body dynamics of a person with respect to said body support structure.

3. The input device of claim 1, wherein said sensor is operative to obtain pressure and pressure distribution data regarding body dynamics of a person with respect to said body support structure.

4. The input device of claim 1, wherein said sensor is further operative to obtain discrete and real-time data regarding body dynamics of a person with respect to said body support structure.

5. The input device of claim 1, wherein said sensor comprises a g rid sensor.

6. The input device of claim 5, wherein said grid sensor is formed into a flexible sheet.

7. An input system comprising:
a chair;
a sensor associated with said chair and operative to obtain data regarding body dynamics of an occupant of said chair;
an interface in communication with said sensor and operative to transform the data into control signals; and
a computer-controlled device in communication with interface and operative to utilize said control signals.

8. The input system of claim 7, wherein said sensor is operative to obtain pressure data regarding body dynamics of a person with respect to said chair.

9. The input system of claim 7, wherein said sensor is operative to obtain pressure and pressure distribution data regarding body dynamics of a person with respect to said chair.

10. The input system of claim 7, wherein said interface includes a driver.

11. The input system of claim 7, wherein said computer-controlled device is one of a game console, a computer, and a processing application.

12. The input system of claim 7, wherein said sensor is further operative to obtain discrete and real-time data regarding body dynamics of a person with respect to said chair.

13. The input system of claim 7, wherein said sensor comprises a grid sensor.

14. The input system of claim 13, wherein said grid sensor comprises a grid sensor formed into a flexible sheet.

15. An input system comprising:
a chair;
a sensor associated with said chair and operative to obtain static and dynamic data regarding a body of an occupant of said chair;
a multiplexer in communication with said sensor and operative to assemble the static and dynamic data into a data stream;
an interface buffer in communication with said multiplexer and operative to receive said data stream and output said data stream as a buffered data stream;
a driver operative to transform said buffered data stream into control signals; and
a computer-controlled device in communication with the driver and operative to utilize said control signals to control an application of the computer-controlled device.

16. The input system of claim 15, wherein said sensor is further operative to obtain discrete and dynamic pressure and pressure distribution data regarding the body of the occupant of said chair.

17. The input system of claim 15, wherein said computer-controlled device is one of a game console, a computer, and a processing application.

18. The input system of claim 15, wherein said sensor comprises a grid sensor.

19. The input system of claim 18, wherein said grid sensors comprises a grid sensor formed into a flexible sheet.

20. A method of providing input signals to a processing application comprising:
obtaining data regarding body dynamics of a person with respect to a body support structure;
transforming the obtained data into control signals; and
providing the control signals to a processing application for controlling at least an aspect of the processing application.

21. The method of claim 20, wherein the step of obtaining data regarding body dynamics of a person with respect to a body support structure includes obtaining pressure data.

22. The method of claim 20 wherein the step of obtaining data regarding body dynamics of a chair includes obtaining pressure data and pressure distribution data.

23. The method of claim 20, wherein the step of transforming the data into control signals includes processing the data via an application driver.

24. The method of claim 20, wherein the step of obtaining data includes utilizing a grid sensor.

25. The method of claim 24, wherein the step of obtaining data utilizing a grid sensor, includes utilizing a grid sensor in the form of a sheet situated on the body support structure.

26. The method of claim 20, wherein the step of transforming the data into control signals includes:
converting raw data received from the sensor into a pressure measure; and
mapping the pressure measure.

27. The method of claim 26, wherein the step of transforming the data into control signals further includes:
continuously remapping the pressure measure; and
comparing a previous map to a current map to obtain real-time data.
